(19) United States
(12) Patent Application Publication
(10) Pub. No.: US 2003/0235415 A1
(43) Pub. Date: Dec. 25, 2003

(54) Optical communication devices and optical communication methods

(76) Inventors: Frank H. Peters, San Jose, CA (US); Jonathan Simon, Castro Valley, CA (US); Scott Corzine, Sunnyvale, CA (US); Clifton L. Anderson, San Jose, CA (US)

Correspondence Address: AGILENT TECHNOLOGIES, INC., Legal Department, DL429, P.O. Box 7599, Intellectual Property Administration, Loveland, CO, 80537-0599, US

(21) Appl. No.: 10/177,053

(22) Filed: Jun. 21, 2002

(51) Int. Cl. H04B 10/04

(52) U.S. Cl. 398/197

(57) ABSTRACT

Optical communication devices and optical communication methods are described. The devices and methods may be implemented in parallel optical communication applications according to some exemplary described aspects to provide enhanced bandwidth. According to one aspect, an exemplary optical communication device includes a plurality of light sources configured in an array and individually adapted to communicate information with respect to an optical communication medium. Individual ones of the light sources are configured to emit light having at least three different and distinct levels to communicate the information with respect to the optical communication medium. The device of this aspect further includes a controller configured to provide a plurality of control signals to control respective ones of the light sources to individually communicate respective information using the at least three different and distinct levels to implement multi-level coding. Other aspects are described.

### TECHNICAL FIELD

The invention relates to optical communication devices and optical communication methods.

### BACKGROUND OF THE INVENTION

Networking has become increasingly popular as a way to exchange information between different devices such as computer systems and telephony devices, for example. Voice and data networks are advancing in sophistication to meet increasing demands for communication of voice and other data.

Parallel optical communication networks are utilized to communicate relatively large amounts of data between sources and destinations. Such parallel optical communication networks may be coupled with central offices, implemented as computer interconnects between source and destination devices as well as utilized in a wide variety of other applications.

Some parallel optical communications applications require very high aggregate bandwidth. In such applications, the number of channels including fibers and detectors can become relatively large requiring significant space. Further, these networks are also relatively expensive to construct and maintain. As the demand for voice and data communications services continues to increase, the demand for networks capable of handling increased bandwidth also increases.

Accordingly, there exists a need to provide improved devices and methodologies to accommodate such demands while minimizing or avoiding problems associated with conventional arrangements.

### SUMMARY OF THE INVENTION

Aspects of the invention relate to optical communication devices and optical communication methods. Aspects of the invention may be implemented in parallel optical communication applications to provide enhanced bandwidth. Aspects of the invention may be used in applications other than communication applications.

According to one aspect of the invention, an optical communication device is provided. An exemplary device according to this aspect includes an optical communication device which comprises a plurality of light sources configured in an array and individually adapted to communicate information with respect to an optical communication medium, wherein individual light sources are configured to emit light having at least three different and distinct levels to communicate the information with respect to the optical communication medium. The device of this aspect further includes a controller configured to provide a plurality of control signals to control respective ones of the light sources to individually communicate respective information using the at least three different and distinct levels to implement multi-level coding.

Another aspect of the invention provides an optical communication method. The method includes providing an array comprising a plurality of light sources emitting light having at least three different and distinct levels using individual ones of the light sources. The method of this aspect further includes controlling the light sources to individually emit light between the at least three different and distinct levels to implement multi-level coding to communicate information and optically coupling the light having the at least three different and distinct levels with an optical communication medium after the controlling.

Another aspect of the present invention also relates to an optical communication method. This method includes receiving a plurality of electrical data signals providing a plurality of control signals responsive to the electrical data signals. The method also includes emitting light comprising a plurality of optical signals individually having at least three distinct and different levels using a plurality of light sources configured in an array and individually comprising a plurality of discrete light emission devices individually having a light emission intensity corresponding to a single one of the at least three different and distinct levels. The method of this aspect also includes controlling the at least three different and distinct levels of the optical signals by controlling the discrete light emission devices using the control signals to implement multi-level coding to communicate information of the electrical data signals and optically coupling the optical signals individually having the at least three distinct and different levels with a plurality of respective optical fibers after the controlling.

According to additional aspects of the invention, a plurality of light emission devices may be implemented upon a monolithic substrate, such as a single semiconductive die. In one operational aspect, plural ones of the monothically implemented lasers may be used to provide redundant communications.

Other aspects of the invention are provided, at least some of which are described in detail below.

### BRIEF DESCRIPTION OF THE DRAWINGS

Preferred embodiments of the invention are described below with reference to the following accompanying drawings depicting examples embodying the best mode for practicing the invention.

FIG. 1 is a functional block diagram of an exemplary optical communication system.

FIG. 2 is a functional block diagram of an exemplary source optical communication device of the optical communication system.

FIG. 3 is a functional block diagram of an exemplary light source of the source optical communication device.

FIG. 4 is an illustrative representation of an exemplary source optical communication device and exemplary optical communication media.

FIG. 5 is a graphical representation of an exemplary optical signal communicated by a source optical communication device.

### DETAILED DESCRIPTION OF THE INVENTION

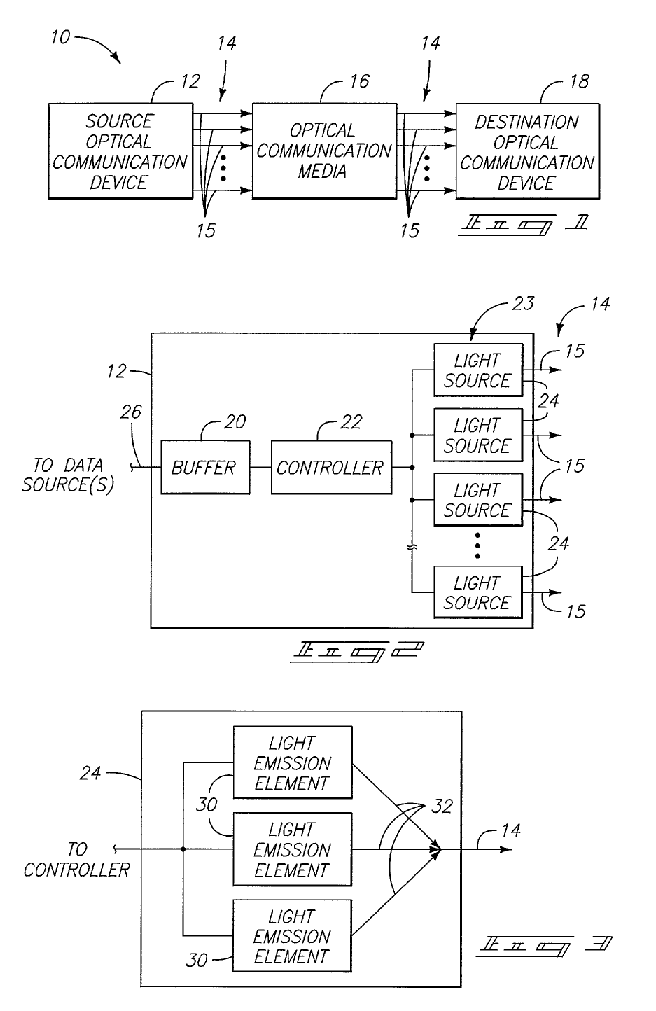

Referring to FIG. 1, an exemplary optical communication system 10 comprises a source optical communication device 12, an optical communication media 16 and a destination optical communication device 18. The depicted exemplary system 10 is implemented in a highly parallel channel environment. Other configurations are possible.

Source optical communication device 12 is configured to generate a plurality of optical signals 14 having data or information encoded thereon for communication. As shown, optical communication system 10 comprises a plurality of channels 15 intermediate source optical communication device 12 and destination optical communication device 18. As described in detail below, source optical communication device 12 is configured to output optical signals 14 corresponding to channels 15 and which individually implement a multi-level coding scheme according to aspects of the present invention. Optical signals 14 are provided to optical communication media 16 for communication to the appropriate destination optical communication device 18. In the described exemplary embodiment, respective optical signals 14 outputted from device 12 are maintained within respective channels 15 throughout optical communication media 16 and before application to destination optical communication device 18. Alternatively, optical signals 14 may be switched from one channel to another as desired.

Optical communication media 16 comprises a plurality of optical waveguides implemented as optical fibers in one embodiment. In the described exemplary embodiment, the number of optical waveguides corresponds to the number of channels 15. Optical communication media 16 may be implemented in any appropriate configuration including free space for communicating optical signals 14.

Destination optical communication device 18 is configured to receive the optical signals 14. Device 18 is configured to distinguish between the plural different and distinct levels within optical signals 14 to receive the multi-level coded data. Destination optical communication device 18 is configured to convert the optical signals 14 into respective electrical signals including the data encoded thereon for further communication of the data.

Referring to FIG. 2, components of an exemplary source optical communication device 12 are depicted. The illustrated source optical communication device 12 includes a buffer 20, a controller 22, and a parallel array 23 comprising a plurality of light sources 24 in the illustrated exemplary configuration. Controller 22 is coupled with buffer 20 and individual light sources 24.

Source optical communication device 12 is configured to couple with external data sources (not shown) which provide information or data to be communicated within optical communication system 10. In the depicted embodiment, buffer 20 is coupled with a bus 26 and is configured to receive data in one or more electrical signal. The received data to be communicated within system 10 is received from appropriate sources, such as the data sources. Bus 26 may be implemented as a plurality of parallel connections, or alternatively, bus 26 is implemented to provide serial communication of data from one or more data source. Electrical data signals may be multiplexed, using for example, time division multiplexing (TDM) within bus 26. Buffer 20 operates as a temporary storage device for received data prior to communication of such data to optical communication media 16.

The array 23 of light sources 24 is coupled with optical communication media 16. In the depicted arrangement, light sources 24 are individually configured to communicate information with respect to optical communication media 16. The number of light sources 24 corresponds to the number of channels 15 provided within optical communication system 10 in one exemplary embodiment. In such an embodiment, light sources 24 communicate optical signals 14 to respective optical fibers or other waveguides of optical communication media 16 corresponding to channels 15.

According to aspects of the present invention, source optical communication device 12 and individual light sources 24 are configured to implement multi-level coding to communicate information received from one or more external data source. Multi-level coding schemes provide a log ₂(n) enhancement to information bandwidth of channels 15 where n is the number of levels used in the coding scheme. As described in further detail below, individual light sources 24, responsive to control from controller 22, emit light having at least three different and distinct levels to communicate the received data with respect to optical communication media 16 and to implement multi-level coding. Light sources 24 are configured to emit optical signals 14 having at least three different and distinct levels in an exemplary embodiment. Additional different and distinct levels may also be provided if additional bandwidth is desired.

In the described exemplary embodiment, controller 22 is configured to provide a plurality of control signals to respective light sources 24 to control or modulate the emission of light therefrom (comprising optical signals 14) at the different and distinct levels. Controller 22 is configured as processing circuitry configured to execute executable instructions to control light sources 24 in the described exemplary embodiment. Controller 22 configured as processing circuitry executes appropriate executable instructions stored within a memory device (not shown). Executable instructions include, for example, software and/or firmware instructions. Controller 22 implemented as processing circuitry comprises a microprocessor in one exemplary embodiment. Controller 22 may be implemented in hardware configurations in other embodiments.

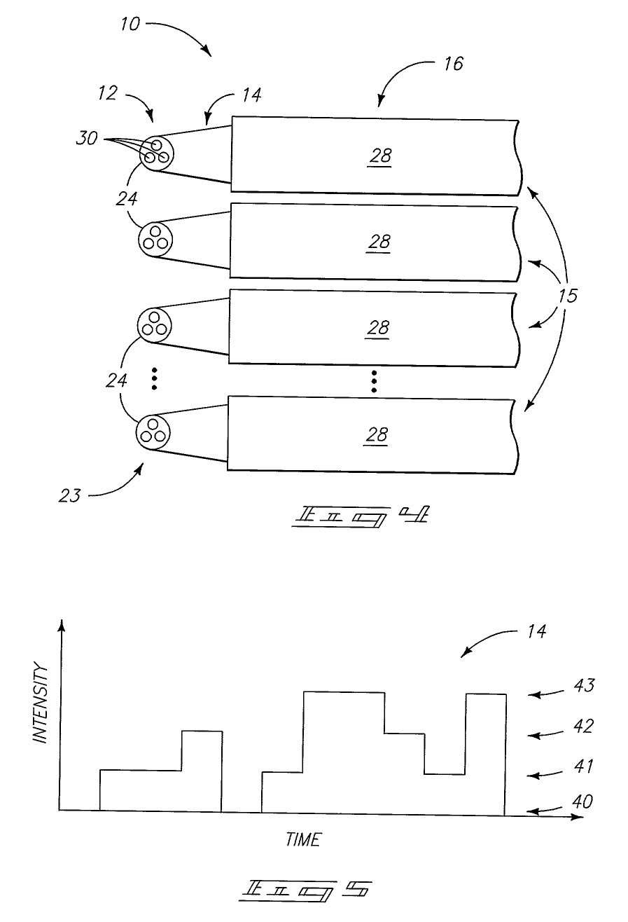

Referring to FIG. 3, further details of an individual light source 24 are described according to one exemplary aspect. Light source 24 comprises a plurality of discrete light emission elements 30 according to one exemplary embodiment. Other light source 24 configurations are possible including configurations having additional discrete light emission elements 30 or a single light emission element 30. In one exemplary embodiment, the light emission elements 30 are implemented as lasers, such as vertical cavity surface emitting lasers (VCSELs).

Light emission elements 30 are individually configured to communicate optical signals 32 which are combined to collectively form an optical signal 14 which is communicated within a respective channel 15 through optical communication media 16 of optical communication system 10. Light emission elements 30 of a single light source 24 are configured to couple light into a single optical waveguide of the optical communication media 16. According to aspects of the present invention, light emission elements 30 are configured to communicate respective optical signals 32 individually having a light emission power or intensity equivalent to a single one of the different and distinct levels of optical signals 14. Further details regarding different and distinct levels of optical signals 14 are described below with reference to FIG. 5.

Referring to FIG. 4, an exemplary implementation of optical communication system 10 is illustrated. Source optical communication device 12 comprises a plurality of light sources 24 as shown. The individual light sources 24 comprise a plurality of light emission elements 30 in the embodiment shown in FIG. 4 and as described above. Light emission elements 30 emit light to form optical signals 14 having different and distinct levels to implement multi-level coding and for communication within optical communication media 16.

Optical communication media 16 is implemented as a plurality of optical waveguides 28 comprising optical fibers in the depicted exemplary embodiment. Individual optical waveguides 28 correspond to a single communication channel 15 within optical communication system 10. Individual light sources 24 output the optical signals 14 for communication within the respective channels 15. At any given moment in time, one or more of channels 15 may not be utilized. In addition, during peak usage, all channels 15 may be utilized to implement communications intermediate source optical communication device 12 and destination optical communication device 18 (FIG. 1).

Controller 22 (FIG. 2) is configured to control the individual light sources 24. More specifically, controller 22 is configured to turn on or off individual light emission elements 30 of light sources 24 to provide a plurality of different and distinct levels within optical signals 14 responsive to data signals received via bus 26. In the described implementation, data signals are provided via bus 26 and controller 22 generates respective control signals for individual respective light sources 24 and channels 15 associated therewith responsive to received respective data signals.

In certain embodiments, two light emission elements 30 may be utilized to provide three different and distinct levels within optical signals 14. As mentioned above, additional (e.g., three or more) light emission elements 30 may be provided within a single light source 24 to provide additional different and distinct levels within optical signals 14 to further enhance bandwidth if desired.

In another embodiment, individual light sources 24 comprise a single light emission element 30. Controller 22 is configured to control such individual light emission element 30 to emit light at a plurality of intensities corresponding to at least three different and distinct levels. According to one embodiment, controller 22 is configured to adjust the control signal applied to the respective light emission element 30. Responsive to an adjustment of the control signal, light emission element 30 is configured to adjust the intensity of the emitted light comprising optical signal 14 to provide corresponding different and distinct levels.

For example, controller 22 may adjust a bias of the control signal to enable light emission element 30 to output the different and distinct levels within optical signals 14. Controller 22 may adjust the bias by adjusting the current of respective control signals responsive to respective data signals according to one exemplary embodiment. Other bias adjustments may be implemented.

Some light emission elements 30, such as vertical cavity surface emitting lasers (VCSELs), are typically not sufficiently linear with current. Thus, in some configurations, it is desired to characterize the non-linearity of the intensity relative to the control signal bias current to provide proper distinct and different levels which are discernable in destination optical communication device 18 if one light emission element 30 is utilized as light source 24. It is preferred to provide the spacing between adjacent levels within accurate tolerances for reception within device 18. If the relationship of bias of the control signal and the corresponding level of the outputted signal is not linear, the relationship may be mapped between the bias and the responsive light intensity outputted from device 30 in order to enable controller 22 to provide control of appropriate spacing between distinct levels within optical signal 14.

Such can be implemented in a map or logic table accessible by controller 22 in one exemplary configuration. For example, responsive to a data signal indicating a desired level of optical signal 14, controller 22 accesses a logic table to retrieve the appropriate bias of the control signal to provide the desired level within optical signal 14. Other configurations are possible.

In some configurations of the present invention, a plurality of lasers, such as vertical cavity surface emitting lasers (VCSELs), may be provided in a monolithic arrangement. For example, a plurality of lasers may be fabricated upon a single monolithic semiconductive substrate, such as a single silicon die, using semiconductor processing techniques.

One or more waveguide 28 may be optically coupled with a monolithic arrangement of the lasers to communicate optical signals 14 generated using the lasers. The waveguide(s) 28 may be individually arranged and configured to communicate optical signals 14 and/or 32 received from one of the lasers or a plurality of the lasers.

The plurality of lasers of a single die may be utilized to provide one or more light source 24 configured to generate a plurality of optical signals 14 individually having a plurality of levels. Depending upon the configuration of lasers and control scheme being utilized, one die may include a plurality of lasers comprising a plurality of light emission elements 30 of one or more light source 24. For example, at least some of the lasers of the die may be configured to provide signals 30 of one or more optical signal 14 individually having a plurality of levels.

In another arrangement, one or all of the plurality of lasers of the die could individually correspond to a light source 24 and be controlled (e.g., via control signal bias adjustment as described above) to output an optical signal 14 having at least three different and distinct levels for one channel 15. In such a configuration, other lasers formed upon the same monolithic die could output another optical signal 14 and/or 32 for another channel 15 and having at least three different and distinct levels.

Accordingly, a plurality of lasers upon a given monolithic die may comprise a plurality of light emission elements 30 utilized to generate a single optical signal 14 as described above and/or one or more other laser of the die may be utilized to form another optical signal 14 either directly or by generating plural optical signals 32 as described above.

Additional aspects of the present invention provide redundancy operations which can be implemented using standard binary communications or multi-level coding schemes described herein. For example, light emission elements 30 of a light source 24 could be utilized in a binary communication scheme wherein all of the elements 30 are controlled to be provided in either an on or off emission state to implement redundant communications (i.e., if one element 30 fails, communications can continue to occur using the remaining elements 30).

Redundancy can also be provided in multi-level communication systems if an adequate number of redundant light emission elements 30 are provided or using a common control signal with appropriate biasing to control a plurality of the lasers in parallel. The elements 30 configured to provide redundant operations may be implemented as discrete configurations (e.g., upon a plurality of respective semiconductive substrates) or upon a single monolithic substrate (e.g., die). The lasers may be configured to simultaneously emit the optical signals to provide redundancy, or alternatively, the lasers may be configured to emit signals at different moments in time (e.g., upon failure of one laser, another laser could be utilized) to provide redundant operations.

Referring to FIG. 5, an exemplary graphical representation of an optical signal 14 is depicted. The graphical representation of FIG. 5 depicts intensity of the optical signal 14 versus a time relationship. The depicted graphical representation includes a plurality of levels of optical signal 14 represented by references 40-43. The graphical representation of FIG. 5 corresponds to a light source 24 having three light emission elements 30 configured to emit an optical signal 14 having four different and distinct levels 40-43 in one exemplary multilevel coding scheme. More or less levels may be provided.

The intensity level of optical signal 14 corresponding to reference 40 corresponds to controller 22 controlling all light emission elements 30 of light source 24 to be in an off condition. Reference 41 corresponds to controller 22 controlling only one of the three light emission elements 30 to output a respective light signal 32 (FIG. 3) and the other elements 30 are off. Reference 42 corresponds to controller 22 controlling two of the three light emission elements 30 to output respective optical signals 32 while the other element 30 is off. Reference 43 corresponds to controller 22 controlling all three of light emission elements 30 to output respective optical signals 32. Optical signals 32 are combined to form optical signal 14 depicted in FIG. 5.

As mentioned above, the exemplary graphical representation of optical signal 14 refers to light source 24 including three light emission elements 30 to provide the four different and distinct levels. Alternatively, the light source 24 comprises a single light emission element 30 and controller 22 controls the appropriate bias of a control signal applied to the light emission element 30 to provide the four different and distinct levels. Other configurations are possible.

What is claimed is:

1. An optical communication device comprising:
a plurality of light sources configured in an array and individually adapted to communicate information with respect to an optical communication medium, wherein individual light sources are configured to emit light having at least three different and distinct levels to communicate the information with respect to the optical communication medium; and
a controller configured to provide a plurality of control signals to control respective ones of the light sources to individually communicate respective information using the at least three different and distinct levels to implement multi-level coding.

2. The device of claim 1 wherein at least one of the light sources comprises a plurality of discrete light emission elements.

3. The device of claim 2 wherein the light emission elements are individually configured to communicate light having a light emission intensity corresponding to a single one of the at least three different and distinct levels.

4. The device of claim 2 wherein the light emission elements are adapted to couple light into a single optical fiber of the optical communication medium corresponding to the at least one light source.

5. The device of claim 2 wherein the light emission elements comprise lasers.

6. The device of claim 1 wherein the light sources individually comprise a plurality of discrete light emission elements.

7. The device of claim 6 wherein the discrete light emission elements are implemented upon a single monolithic substrate.

8. The device of claim 6 wherein the light emission elements are individually configured to communicate light having a light emission intensity corresponding to a single one of the at least three different and distinct levels.

9. The device of claim 6 wherein the controller is configured to control the discrete light emission elements to communicate substantially the same optical signals.

10. The device of claim 1 wherein at least one of the light sources comprises a light emission element individually configured to emit light at a plurality of intensities corresponding to the at least three different and distinct levels.

11. The device of claim 10 wherein the controller is configured to adjust the respective control signal for the at least one light source, and the light emission element is configured to adjust the intensity of the emitted light responsive to the adjustment.

12. The device of claim 1 wherein the light sources are adapted to communicate with a plurality of respective optical fibers of the optical communication medium comprising a plurality of respective communication channels.

13. The device of claim 1 wherein the light sources are implemented upon a single monolithic substrate.

14. An optical communication method comprising:
providing an array comprising a plurality of light sources;
emitting light having at least three different and distinct levels using individual ones of the light sources;
controlling the light sources to individually emit light between the at least three different and distinct levels to implement multi-level coding to communicate information; and
optically coupling the light having the at least three different and distinct levels with an optical communication medium after the controlling.

15. The method of claim 14 wherein the emitting comprises emitting using at least one of the light sources comprising a plurality of discrete light emission elements comprising lasers.

16. The method of claim 14 wherein the emitting comprises emitting using at least one of the light sources comprising a plurality of discrete light emission elements.

17. The method of claim 16 wherein the optically coupling comprises optically coupling the light from the light emission elements of the at least one light source with a single respective optical fiber of the optical communication medium.

18. The method of claim 14 wherein the emitting comprises emitting using at least one of the light sources comprising a plurality of discrete light emission elements individually having a light emission intensity corresponding to a single one of the at least three different and distinct levels.

19. The method of claim 18 wherein the emitting comprises emitting using the discrete light emission elements implemented upon a single monolithic substrate.

20. The method of claim 18 wherein the controlling comprises controlling the discrete light emitting elements to emit substantially the same optical signals.

21. The method of claim 14 wherein the emitting comprises emitting using the light sources individually comprising a plurality of discrete light emission elements individually having a light emission intensity corresponding to a single one of the at least three different and distinct levels.

22. The method of claim 14 wherein the emitting comprises emitting using the light sources individually comprising a plurality of discrete light emission elements.

23. The method of claim 14 wherein the emitting comprises emitting using at least one of the light sources comprising a light emission element individually configured to emit light having a plurality of intensities corresponding to the at least three different and distinct levels.

24. The method of claim 14 wherein the optically coupling comprises optically coupling the light with the optical communication medium comprising a plurality of optical fibers comprising a plurality of communication channels and corresponding to respective ones of the light sources.

25. The method of claim 14 wherein the providing the array comprises providing the array of light sources using a single monolithic substrate.

26. An optical communication method comprising:
receiving a plurality of electrical data signals;
providing a plurality of control signals responsive to the electrical data signals;
emitting light comprising a plurality of optical signals individually having at least three distinct and different levels using a plurality of light sources configured in an array and individually comprising a plurality of discrete light emission devices individually having a light emission intensity corresponding to a single one of the at least three different and distinct levels;
controlling the at least three different and distinct levels of the optical signals by controlling the discrete light emission devices using the control signals to implement multi-level coding to communicate information of the electrical data signals; and
optically coupling the optical signals individually having the at least three distinct and different levels with a plurality of respective optical fibers after the controlling.

27. An optical communication method comprising:
providing a monolithic substrate including a plurality of lasers;
providing a control signal to control emission of light using the lasers;
emitting a plurality of optical signals using the plurality of lasers and responsive to the control signal, the optical signals being substantially the same to implement redundant communications; and
optically coupling the optical signals with a single optical medium providing a single channel to communicate the optical signals.

28. The method of claim 27 wherein the emitting comprises simultaneously emitting the optical signals.

29. The method of claim 27 wherein the emitting comprises emitting the optical signals at different moments in time.

30. The method of claim 27 wherein the providing the control signal comprises providing the control signal to control the emission of light to implement multi-level coding communications.

31. The method of claim 27 wherein the providing the control signal comprises providing the control signal to control the emission of light to implement binary communications.

32. The method of claim 27 wherein the providing the monolithic substrate comprises providing a semiconductive substrate.
